(19) United States
(12) Patent Application Publication
(10) Pub. No.: US 2024/0013960 A1
(43) Pub. Date: Jan. 11, 2024

(54) Field Quality Correction In No-Insulation Superconducting Magnets By Adjustable Current Bypasses

(71) Applicants: Massachusetts Institute of Technology, Cambridge, MA (US); Commonwealth Fusion Systems LLC, Cambridge, MA (US)

(72) Inventors: Alexey RADOVINSKY, Cambridge, MA (US); Robert MUMGAARD, Boston, MA (US); Theodore GOLFINOPOULOS, Cambridge, MA (US)

(73) Assignees: Massachusetts Institute of Technology, Cambridge, MA (US); Commonwealth Fusion Systems LLC, Cambridge, MA (US)

(21) Appl. No.: 17/796,481

(22) PCT Filed: Mar. 1, 2021
(86) PCT No.: PCT/US2021/020225

§ 371 Date: Jul. 29, 2022

Related U.S. Application Data
(60) Provisional application No. 62/987,486, filed on Mar. 10, 2020.

(51) Int. Cl. H01F 6/06

(52) U.S. Cl. CPC H01F 6/06

(57) ABSTRACT

A magnet system and method of operating may be used in connection with operating a superconducting electromagnet, for example in a tokamak. The magnet system includes a coil having windings retained within a non-insulated structure, so that current can pass both along the windings to generate a magnetic field, and between the windings. The amount of current passing through the coil is trimmed using a bypass circuit, coupled in parallel to the coil terminals. The bypass circuit is controlled on the basis of measurements of the field components to divert current from passing through the field coil. In this way, the magnetic fields of each of multiple field coils can be brought into mutual uniformity.

### FIELD

The disclosure pertains generally to fusion reactors with magnetic plasma confinement, and more particularly to trimming of magnetic fields in toroidal field coils.

### BACKGROUND

Nuclear fusion occurs when matter is heated into a plasma whose positively charged nuclei have such a high kinetic energy that their attractive strong nuclear forces can overcome their repulsive electrostatic forces. However, for practical use a plasma must be safely confined when it reaches temperatures high enough for fusion to occur, e.g. about 15 keV or 170 million degrees for deuterium-tritium fusion. In some fusion reactors, the plasma is confined by applying external magnetic fields (and in the case of tokamak reactors, a current through the plasma itself) that bend and twist the movement of its ions into a desired shape that also facilitates nuclear fusion. At temperatures high enough to cause fusion, very strong magnetic fields are required to contain the plasma, with flux densities on the order of several Tesla—over a thousand times stronger than a typical refrigerator magnet.

### SUMMARY OF DISCLOSED EMBODIMENTS

Disclosed embodiments improve the operation of a tokamak having non-insulated TF coils by providing programmable current bypass circuits (electrical shunts) across the terminals of individual field coils that are connected in series. The amount of current passing through each coil is trimmed using a bypass circuit, coupled in parallel to the coil terminals. The bypass circuit is controlled on the basis of measurements of the magnetic field components to divert a small fraction of current from passing through the coil.

In this way, the magnetic fields of each of multiple coils can be brought into mutual uniformity, helping to correct the error resulting from the initial reduction in ampere-turns. Usually the coil is comprised of multiple turns of the winding, each contributing to the total magnetic field produced by the coil. One unit of the current diverted into the bypass produces a total coil field correction, amplified by the number of the turns in the winding. Thus, diverting a small portion of the total current into the bypass results in a relatively large adjustment in the total magnetic field produced by the TF coil.

Thus, a first embodiment is a magnet system comprising a coil and a bypass circuit. The coil has first and second terminals, a plurality of windings comprising a high temperature superconductor coupled between the first and second terminals, and conductive material disposed between, and in electrical contact with, each of the plurality of windings. The bypass circuit is coupled to the first and second terminals of the coil in parallel with the plurality of windings, and has one or more controllable, current-carrying paths wherein multiple such paths are arranged in parallel with each other.

In some embodiments, the coil does not include any insulating material disposed between windings of the plurality of windings.

In some embodiments, the bypass circuit is coupled to the first and second terminals of the coil via a superconducting bus.

In some embodiments, at least one of the current-carrying paths comprises a switch. At least one of the current-carrying paths may include a resistor in series with the switch.

In some embodiments, the switch is a transistor. The transistor may be a metal-oxide-semiconductor field-effect transistor (MOSFET), and the bypass circuit may include many, and in some cases at least one hundred current-carrying paths, each such path comprising a transistor.

In some embodiments, the switch comprises a superconducting material.

In some such embodiments, the switch is in an open state when the superconducting material is above its critical temperature, and the switch is in a closed state when the superconducting material is below its critical temperature. Such embodiments may further include a heating element for maintaining the superconducting material above its critical temperature. In some such embodiments, the bypass circuit comprises at least ten current-carrying paths, each such path comprising a switch having the superconducting material.

Alternately in some such embodiments, the switch is in an open state when the superconducting material is above its critical field, and the switch is in a closed state when the superconducting material is below its critical field. Such embodiments may further include an electromagnet or a movable permanent magnet for opening or closing the switch.

In some embodiments, the bypass circuit includes a normally-conducting resistor whose resistance may be varied by controlling its temperature.

Some embodiments further include a resistor in series with the plurality of windings.

Some embodiments further include a controller for opening or closing the controllable, current-carrying paths in the bypass circuit, the controller operatively coupled to a magnetic field sensor for measuring a magnetic field produced by the plurality of windings, or to a current sensor for measuring a current passing through the plurality of windings, or to both the magnetic field sensor and the current sensor.

A second embodiment is a method of operating a magnet system comprising a superconducting electromagnet having first and second terminals and a bypass circuit coupled to the first and second terminals. The method begins with providing a current through the superconducting electromagnet to thereby cause the superconducting electromagnet to produce a magnetic field. The method next includes measuring at least one field component of the produced magnetic field. The method then includes, based on the measurement, diverting a portion of the current through the bypass circuit, thereby trimming the current through the superconducting electromagnet.

In some embodiments, measuring the at least one field component of the magnetic field produced by the superconducting electromagnet comprises measuring either a toroidal component or a radial component of the field of the superconducting electromagnet.

In some embodiments, measuring the at least one field component of the magnetic field produced by the superconducting electromagnet comprises measuring a current flow within the superconducting electromagnet and determining the at least one field component based on the measured current flow.

In some embodiments, the bypass circuit comprises a plurality of switches coupled in parallel, and diverting the portion of the current through the bypass circuit comprises opening or closing a set of one or more switches of the plurality of switches.

In some embodiments, the set of switches comprises transistors, and opening or closing the set of switches comprises adjusting a voltage coupled to one or more of the transistors. Opening or closing the set of switches may include operating the transistors at a temperature below 80K.

In some embodiments, opening or closing the set of switches comprises adjusting a temperature of switches in the set. Adjusting the temperature may include enabling or disabling a heating element in proximity to the set of switches, or directing a cryogen toward or away from the set of switches.

In some embodiments, opening or closing the set of switches comprises changing a magnetic field incident on the set of switches. Changing the magnetic field may include charging or discharging a fixed electromagnet in proximity to the set of switches, or moving a permanent magnet toward or away from the set of switches.

Another embodiment is a magnet system having a coil and a shunt circuit coupled in parallel to the coil. The coil includes a plurality of windings of a high temperature superconductor, and conductive material arranged between and contacting windings of the plurality of windings, thereby forming an electrically conductive path between windings of the plurality of windings.

In some embodiments, the shunt circuit comprises a resistive circuit, which may have a variable resistance. The shunt circuit may include at least one controller configured to adjust the resistance of the resistive circuit.

The resistive circuit may include a plurality of switches coupled in parallel. The switches may be solid state switches, such as MOSFETs, and the resistive shunt may include at least 100 of the solid state switches. Switches of the plurality of switches may be coupled in series to respective resistors.

In some embodiments, switches of the plurality of switches comprise a superconducting material and are configured to be in an open state when the superconducting material is above its critical temperature.

In some embodiments, switches of the plurality of switches comprise a superconducting material and are configured to be in a closed state when the superconducting material is above its critical temperature.

In some embodiments, the coil does not include any insulating material arranged between windings of the plurality of windings.

Another embodiment is a method of operating a magnet system. The magnet system has a magnet and a resistive shunt coupled in parallel to the magnet. The magnet includes a coil comprising a plurality of windings of a high temperature superconductor and conductive material arranged between and contacting windings of the plurality of windings, thereby forming an electrically conductive path between windings of the plurality of windings. The method includes first measuring at least one field component of a magnetic field produced by the magnet, then adjusting a resistance of the resistive shunt based on the measurement of the at least one field component of the magnetic field produced by the magnet.

In some embodiments, measuring the at least one field component of the magnetic field produced by the magnet comprises measuring an azimuthal field of the magnet.

In some embodiments, measuring the at least one field component of the magnetic field produced by the magnet comprises measuring a radial field of the magnet.

In some embodiments, measuring the at least one field component of the magnetic field produced by the magnet comprises measuring a current flow within the coil and determining the at least one field component based on the measured current flow.

In some embodiments, the resistive shunt is coupled to the magnet via a superconducting bus.

In some embodiments, the resistive shunt comprises a plurality of switches coupled in parallel, and wherein adjusting the resistance of the resistive shunt comprises opening and/or closing one or more switches of the plurality of switches.

In some embodiments, opening and/or closing the one or more switches comprises adjusting the temperature of the one or more switches.

In some embodiments, the one or more switches include a superconducting bypass and wherein adjusting the temperature of the one or more switches comprises disabling a heating element coupled to the superconducting bypass.

In some embodiments, the one or more switches include a superconducting bypass and wherein adjusting the temperature of the one or more switches comprises directing a cryogen to lower the temperature of the superconducting bypass.

In some embodiments, the one or more switches are solid state switches, and wherein opening and/or closing the one or more switches comprises adjusting a voltage coupled to each of the one or more switches.

In some embodiments, the plurality of switches are at a temperature below 80K.

It is appreciated that the concepts, techniques, and structures disclosed herein may be embodied in other ways, and that the embodiments summarized above are illustrative, not limiting.

### DESCRIPTION OF THE DRAWINGS

The manner and process of making and using the disclosed embodiments may be appreciated by reference to the drawings, in which:

FIG. 1 schematically shows a simplified tokamak design as known in the art;

FIG. 2 schematically shows a circuit model of a magnet system having a toroidal field coil and a current bypass circuit in accordance with an embodiment of the concepts, techniques, and structures disclosed herein;

FIG. 3 schematically shows a circuit model of a magnet system in accordance with a first embodiment in which the current bypass circuit includes many parallel (e.g. solid state) transistors for controlling the bypass current;

FIG. 4 schematically shows a circuit model of a magnet system in accordance with a second embodiment in which the current bypass circuit includes a set of parallel (e.g. superconducting) switches for limiting the bypass current according to fixed resistors;

FIG. 5 schematically shows a circuit model of a magnet system in accordance with a third embodiment in which the current bypass circuit includes a set of parallel (e.g. 25 superconducting) switches for limiting the bypass current according to the critical current;

FIGS. 6(a) and 6(b) show computations of the toroidal components of the magnetic field outside the toroidal field coils for three different scenarios;

FIG. 7 shows a computation of the radial components of the magnetic field outside the toroidal field coils;

FIG. 8 is a flowchart for a method of operating a magnet system having a superconducting electromagnet and a bypass circuit; and

FIGS. 9A and 9B illustrate implementations of a bypass circuit using normally-conducting and mechanical means, respectively.

### DETAILED DESCRIPTION

As used herein, “critical temperature” refers to a temperature at which a material changes phase between a superconducting state and a non-superconducting state.

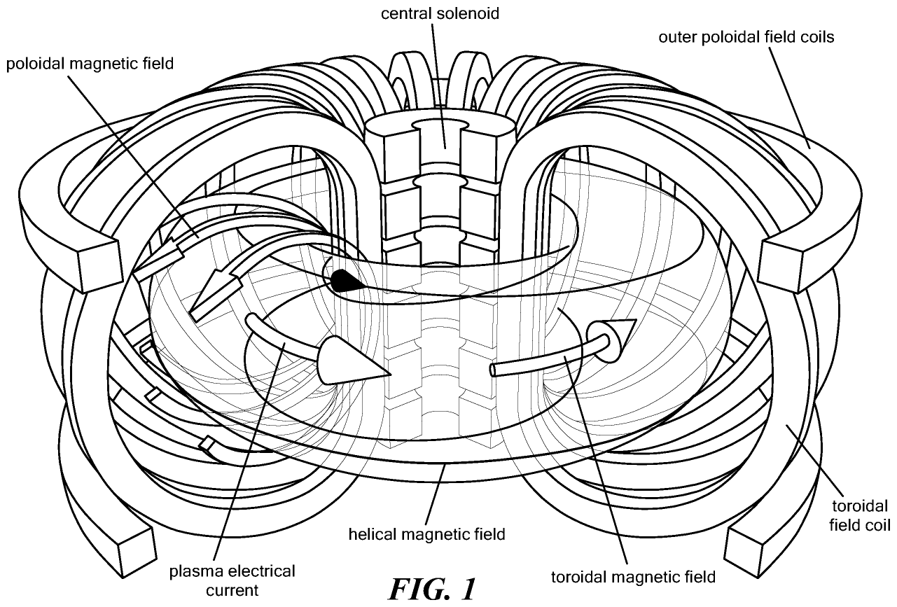

In tokamaks, such as the simplified tokamak shown in FIG. 1, magnetic confinement fields are produced primarily by passing electrical current through several large solenoids called toroidal field (“TF”) coils that surround the vessel containing the plasma. To generate strong enough magnetic fields, a very high current must pass through each of these coils, and to avoid current losses due to electrical resistance, superconducting wire often is used for this purpose. However, each superconducting material has a maximum current that it can carry, called its “critical current”, above which it loses its superconducting properties and becomes normally resistive. An unplanned loss of superconductivity in a magnet is known as a “quench”, and rapidly results in magnet shutdown and dissipation of its stored energy in modes that can degrade the performance of the magnet or its associated electronics, in some cases destructively. Nevertheless, tokamak operators often operate TF coils at or very near their critical currents to achieve the highest possible plasma temperatures.

For many superconducting wires made of a single material, the transition from a superconducting state to a normal state occurs quite sharply near the critical current. Some field coils retain their windings in an electrically insulating structure to prevent this unwanted event, or for other reasons (e.g. due to design history, or for shorter magnet charging and discharging times, or for nearly-strict current-to-field linearity).

When a coil is operated near its critical current, a localized material defect in the wire may cause a portion of the wire to carry greater than the critical current. In a system having insulated windings, no electrical path exists along which the excess localized current may escape, and even a transient excess may lead to an undesirable magnet quench. This particular problem may be avoided by using TF coils that include a large conducting (e.g. copper) azimuthal stabilizer or matrix, or instead retain the wire in an electrically conducting (i.e. “non-insulated”) structure that permits localized excess currents to be drained off through the structure itself. Other reasons not to insulate TF coils include: eliminating the possibility of arcing, avoiding a difficult and failure-prone insulating step during coil manufacture, and the ability to independently optimize cooling and current paths without breaking insulation, among others. However, currents that pass between the windings must be carefully controlled in a non-insulated setting.

One of the significant differences between insulated and non-insulated coils is that different non-insulated TF coils around the tokamak may differ in their total number of ampere-turns. This can happen for a variety of reasons, including but not limited to: the local proximity of the transport current to the critical current, variability of critical current properties along the winding, and resistance of electrical joints internal to the coil that connect parts of the superconducting winding. The general consequence is that, in part of such a non-insulated coil, the transport current will travel radially, partially or completely bypassing part of a turn, the whole turn, or several whole turns. The coil may still be operational but the magnetic field will become distorted. This current diversion will reduce the total number of ampere-turns in the spiral winding, and respectively the magnetic field produced by the coil, causing additional ripple of the toroidal field. One way to compensate this imbalance is by adding a system of trim coils within the volume of each TF coil, but doing so requires additional pairs of current leads, one pair per coil, which is a disadvantageous design. Moreover, these turns add to the existing nominal winding, competing for the valuable space in the TF coil cross section.

Embodiments of the concepts, techniques, and structures disclosed herein permit recovery of fault conditions in tokamak toroidal field coils having non-insulated windings. It is appreciated that embodiments may be used in other electromagnetic coils, and that a person having ordinary skill in the art would understand how to adapt the teachings of the present disclosure for such use. In coils that have current transverse to the windings (sometimes called “bad” coils herein), this current skips over one or more of the windings, and the nearby magnetic field of the tokamak becomes distorted. In accordance with disclosed embodiments, a magnetic field produced by each of the coils that lack this unwanted transverse current (sometimes called “good” coils herein) is reduced to compensate for the “bad” coil or coils, by diverting part of the operating current into a bypass circuit installed across its terminals. In this way, the distortion of the magnetic field is removed.

In particular, a similar scheme can be used to adjust the field of a magnetic resonance imaging (“MRI”) solenoid comprised of multiple pancakes, wound of HTS tape using a no-insulation technique. In such magnets, fields contributed by different pancakes can differ from the expected values by a fraction of the operating current diverted to the radial direction. High field quality requirements, typical for the Mill magnets, can be at least partially accomplished by using bypasses between terminals of single or double pancakes comprising the solenoid.

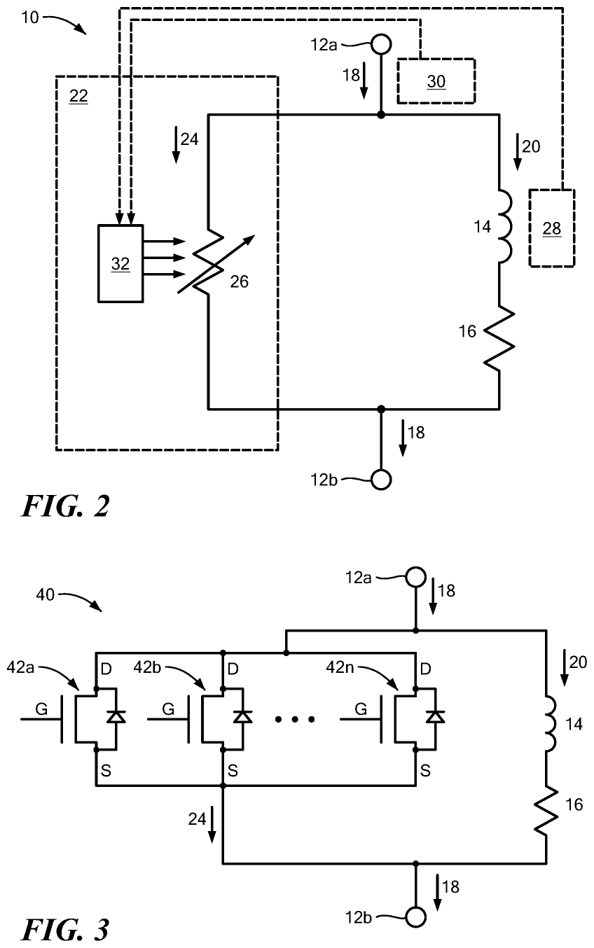

FIG. 2 schematically shows a circuit model of a magnet system 10 comprising a TF coil and a current bypass circuit (electrical shunt) in accordance with an embodiment of the concepts, techniques, and structures disclosed herein. The magnet system 10 includes two terminals 12a, 12b for a TF coil having windings 14 and an internal resistance 16. In ordinary operation, a current 18 is provided from the input terminal 12a, which passes through the components 14 and 16 of the TF coil as the current 20, and which exits via the output terminal 12b.

Embodiments of the concepts, techniques, and structures disclosed herein modify the known TF coil circuit just described by adding an electrical shunt or bypass circuit 22. In embodiments, the current 18 presented at the input terminal 12a travels to the output terminal 12b via two paths: one through the components 14 and 16 of the TF coil as current 20, and one through the bypass circuit 22 as current 24. Neglecting any losses, the input current 18 equals the sum of the operating current 20 and the bypass current 24, which again equals the output current 18.

The bypass circuit 22 has a controllable resistance 26; by controlling suitable elements of the magnet system 10, the magnitude of the resistance 26 may be controlled. Since the voltage drop between the first and second terminals 12a, 12b is the same across the TF coil and the bypass circuit 22, the resistance 16 from the TF coil and resistance 26 from the bypass circuit 22 yield inverse proportional currents, namely current 20 and current 24 respectively. Various circuit models for implementing the bypass circuit 22 and its controllable resistance 26 are shown in FIGS. 3 through 5.

A tokamak or other magnetic system may in general comprise numerous instances of the TF coil circuit shown in FIG. 2, wherein each of the TF coils is coupled in parallel to an electrical shunt or bypass circuit as shown. In such a system, when a “bad” coil has lost operating current through a single winding or turn due to transverse current, the coil current 20 drops by a factor of 1/N, where N is the total number of windings in the coil. Thus, to restore a uniform shape to the magnetic field, the remaining “good” coils in the system are trimmed to equalize operating current with the bad coil by controlling their respective electrical shunt or bypass circuits to divert the same factor 1/N of the total current through their attached shunts. This diversion is accomplished by reducing the resistance 26 of each shunt, as described below in more detail. Thus, the non-operating current lost in the bad coil is equalized by non-operating current diverted through the shunts around the good coils, so that each coil has the same amount of operating current passing through it.

It is appreciated that reducing the operating current 20 in each TF coil winding 14 will reduce the magnitude of the operating magnetic field, and that the tokamak may need to be adjusted accordingly in ways other than trimming current using the above-described shunts. For example, after the good coils have been appropriately trimmed to match the bad coil's reduced operating current 20, the current present at the input terminal of each good coil may be increased to bring each coil back to the nominal operating current.

In one model of a tokamak system, each TF coil windings 14 may have N=220 turns, the coil resistance 16 may be about 50 nΩ, the shunt resistance 26 illustratively may be greater by a factor of N, i.e. 11 μΩ, and the current 20 may be about 25 kA. Power dissipation in each shunt 22 is about 140 mW per dropped turn. The power dissipation for all of the TF coils is the per-shunt power loss multiplied by the number of good coils that must be shunted. In a typical system having 18 total coils, if one coil is bad then the total power loss is 17 times the shunt loss, or about 2.38 W. Advantageously, this power loss is much less than the cryogenic loss for multiple current leads if trim coils were used instead. Moreover, this power loss can be absorbed easily by an existing cooling system that cryogenically cools the magnet system.

Of course, these numbers are only illustrative, and a person having ordinary skill in the art should appreciate how to adjust them to electromagnets having other operating parameters. In particular, the coil resistance 16 may not be exactly 50 nΩ but may arise naturally from tape dropouts, proximity of the operating current to the critical current, properties of internal electrical joints, or a number of other conditions. However, design bypass resistance 26 and all voltages and power losses will scale linearly with the coil resistance 16.

In illustrative embodiments, sensors measure the magnetic field of individual coils to provide the information for adjusting the variable bypass resistors. In some embodiments, a magnet system may comprise a magnetic field sensor 28 provided for measuring the field directly. For instance, a magnet system may comprise a magnetic field sensor 28 on the outer surface of the outer legs of one or more of the TF coil windings 14. This arrangement may be a good location for direct measurements, since the fringe fields from other coils (not shown) are small compared with the self-field of the coil with the attached sensor 28.

Alternately or in addition, a magnet system may comprise a current sensor 30 (e.g. a non-intrusive, fiber optic sensor) for measuring the magnetic field using current as a proxy. Such a sensor may comprise a fiber optic loop next to the current-carrying wire and be configured such that linearly-polarized light passing through the fiber optic loop next to the wire rotates its polarization in proportion to the current present in the wire. The sensor may thereby produce a measurement of this rotation as an indication of a magnitude of the current. This reading of azimuthal current is then mapped into an estimate of the magnetic field that will be generated by the coil (i.e. as a “feed forward” measurement, rather than a “feedback” one as with the magnetic field sensor 28). The readings of these sensors 28 and/or 30 may be calibrated in view of an “ideal” uniform current distribution in all coils, which is determined by the tokamak design parameters.

The sensors 28 and/or 30 may feed their readings into a controller 32 for opening or closing current-carrying paths in the bypass circuit 22. The controller 32 may be implemented, for example, using programmable hardware, software, or a combination of these (e.g. using a computer or computing system) to control physical switches based on readings received from the sensor 28 and/or sensor 30 as described in detail below.

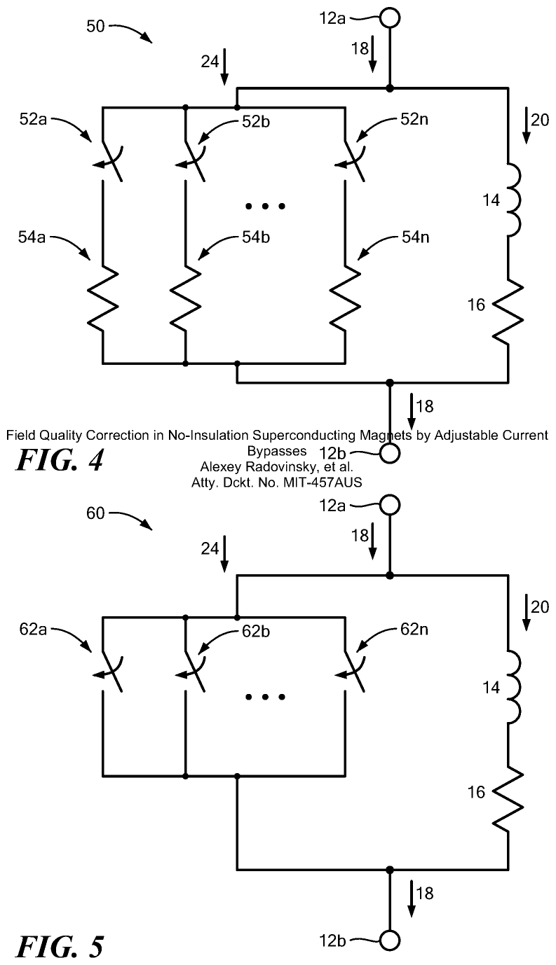

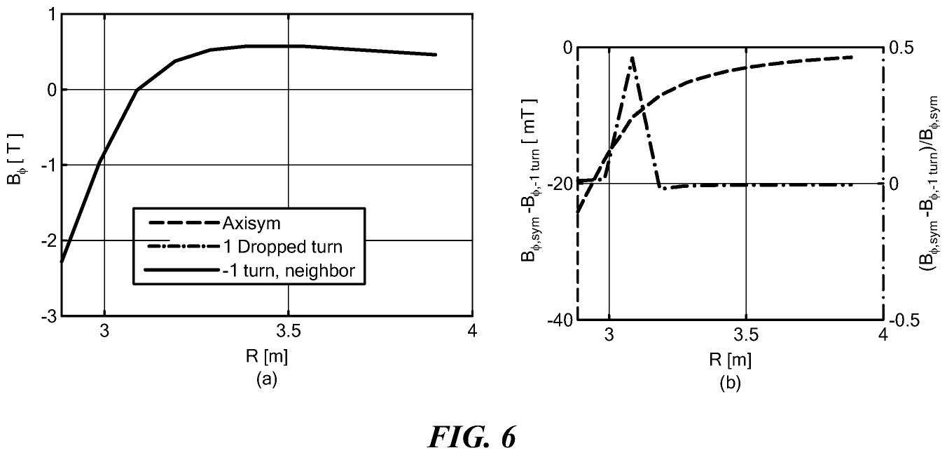

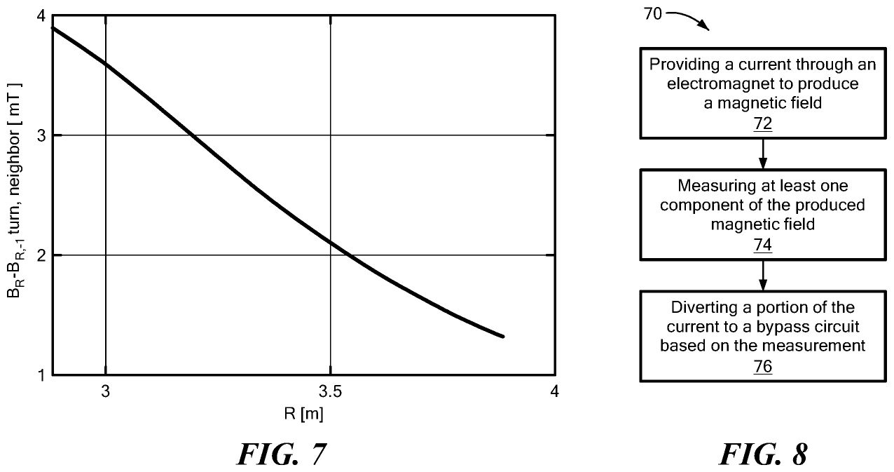

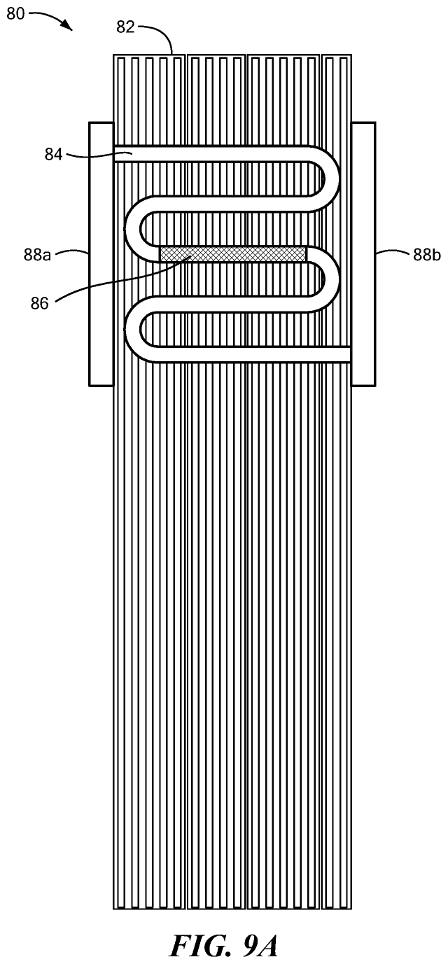

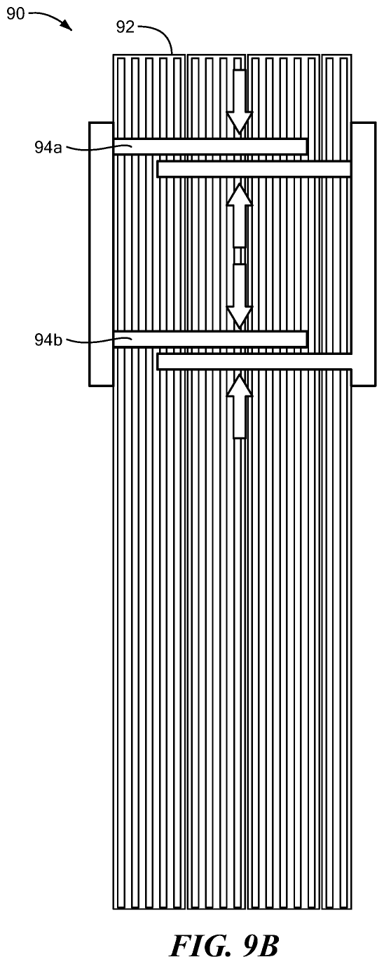

The remainder of this disclosure presents several schemes for implementing a bypass shunt path to trim toroidal field coil currents. A solid-state scheme, shown in FIG. 3, employs metal-oxide-semiconductor field-effect transistors (MOSFETs) or equivalent switches, operated at either room or cryogenic temperatures depending on MOSFET performance characteristics. Two additional schemes, shown in FIGS. 4 and 5, employ superconducting switches that are enabled either by disabling a heater, or enabling a cryogen cooling path, or by changing the local magnetic field at the shunt to drop below the critical field. In all cases, a parallel shunt path is provided. The feasibility of measuring the error is presented in connection with FIGS. 6(a), 6(b), and 7. A method of operating a magnet system having a current bypass is presented in connection with FIG. 8, and two cartoons showing implementations of a bypass circuit using normally-conducting and mechanical means, respectively, are shown in FIGS. 9A and 9B.

Thus, in FIG. 3 is shown a magnet system 20 in accordance with a first embodiment in which the current bypass circuit includes many parallel (e.g. solid state) transistors for controlling the bypass current. Numerous MOSFETs, or other solid-state switches, may be connected in parallel such that the parallel combination of the on-resistance of the switches approaches the desired shunt resistance, noting that the MOSFETs will be in the linear (ohmic) regime due to low drain-source voltage. This approach offers the flexibility of high granularity and controllability of the shunt resistance, as well as low power and simple control mechanisms. MOSFETs operating at cryogenic temperatures (e.g. 77 K via liquid nitrogen) are available; this is desirable so as to avoid a feedthrough from the cryostat for the current leads. However, it may prove more convenient in some designs to use MOSFETs that operate at room temperature. It is expected that a person having ordinary skill in the art will be able to choose the appropriate switches based on design restrictions and desired performance characteristics.

The current bypass circuit of FIG. 3 has many parallel MOSFET transistors 40a, 40b, . . . 40n (collectively “transistors 40”) that are switchable for controlling the bypass current 24. The shunt resistance falls with the activation of each parallel current-carrying path until the desired value is achieved. In particular, the more of the transistors 40 that are closed, the greater the bypass current 24. Each transistor provides a resistance when closed (e.g. by a controller such as controller 32 supplying an appropriate gate voltage), and the number of transistors 40 is chosen so that the bypass circuit provides an appropriate range of resistances, noting again that the transistors 40 will be in a linear (ohmic) regime. Illustratively, if each of the transistors 40 has an inherent resistance of about 5 mΩ, then about 450 or so parallel transistors 40 are required to produce an equivalent resistance of about 11μΩ, in line with the design parameters modeled above. In any event, illustrative embodiments may have at least one hundred current-carrying paths, each such path having a transistor. Of course, the number of transistors in an embodiment will vary with their inherent resistance and the desired equivalent resistance, the latter being a function of the TF coil design.

FIG. 4 schematically shows a magnet system 30 in accordance with a second embodiment in which the current bypass circuit includes a set of parallel switches 52a, 52b, . . . 52n (collectively “switches 52”) for limiting the bypass current 24 according to fixed resistors 50a, 50b, 50n (collectively “resistors 50”). The switches 52 may be formed from a superconducting material, such as a high-temperature superconducting tape. Each of the switches 52 is open when the resistance is made to be very high (i.e., the tape is above its critical temperature and/or critical magnetic field), and is closed when the resistance is made to be very low (i.e., the tape is below its critical temperature and/or critical magnetic field). To attain controllability of the bypass resistance in an appropriate range, the switches 52 are connected in parallel, each with a fixed resistance of perhaps 100 μΩ or greater. Illustratively, at 110 μΩ each, ten parallel current-carrying paths are required to produce an equivalent resistance of 11 μΩ in accordance with the design parameters discussed above. The number of switches in an embodiment will vary with their fixed resistance and the desired equivalent resistance, the latter being a function of the TF coil design.

A superconducting switch may be closed either by a controller (such as controller 32) disabling a nearby heating element to let a superconducting bypass relax to cryogenic temperatures (see FIG. 9A), or the controller by activating a cryogen (e.g. liquid nitrogen) flow loop to enable a superconducting pathway. Other methods of closing a superconducting switch by the controller include turning off an electromagnet that is close enough to the switch to drop the local magnetic field beneath the critical field magnitude, or turning the electromagnet on to shield the switch from an external field, or physical moving away a permanent magnet that otherwise inhibits the switch due to a locally-high magnetic field. A person having ordinary skill in the art may envision other ways to accomplish this function without deviating from the other concepts, techniques, or structures taught herein.

FIG. 5 schematically shows a circuit model of a magnet system 40 in accordance with a third embodiment in which the current bypass circuit includes a set of parallel switches 60a, 60b, 60n (collectively, “switches 60”) for limiting the bypass current 24 according to the critical current, rather than according to fixed resistors as in FIG. 4. In the embodiment of FIG. 5, a small set (e.g. 1-10) of superconducting switches 60 are connected in parallel, again with activation achieved either by a controller (such as controller 32) disabling a heater, or activating a cryogen loop, or otherwise perturbing the local magnetic field around the switches in a manner opposite to those methods described above.

However, rather than modulating the bypass current 24 by controlling parallel resistance as in the embodiment of FIG. 4, the addition of each parallel superconducting path in FIG. 5 provides a somewhat discrete contribution to the shunt current 24, where each contribution is limited by the critical current of the corresponding pathway rather than by a resistance. In particular, the more of the switches 60 that are closed, the greater the bypass current 24. It is assumed that the stabilizer and surrounding material around the superconducting bypass is of sufficiently high resistance so as not to contribute significant bypass current at the relevant voltages. Critical currents well below 100 A are desirable from the aspect of controllability, though if this granularity is deemed unnecessary, then a single pathway may be used; in principle, one superconducting tape would be adequate, which would provide a high critical exponent system, though a larger number of tapes or current-carrying elements are desirable from the perspective of robustness.

It is appreciated that other means may be used to control the variable resistor 26 of FIG. 2. For example, rather than using a section of superconductor as a switch, the critical current of the section may be controlled (e.g. by a controller 32) on a continuum via variable temperature control, or by a variable applied magnetic field. In this manner, the section may be adjusted from normal conductor to superconductor, increasing the critical current until the desired bypass current 24 is achieved. For temperature-based control, the section would be kept warm, either by heaters or lack of cooling, until the desired bypass current 24 is reached, at which point the sample is cooled with shunt current or error field providing feedback for temperature control. For field-based control, when no bypass current 24 is desired, the section is exposed to a relatively high field, either applied from purpose-built local coils or from background field. The local-field coils would be deactivated, or the background field excluded by coils, when bypass current is needed, with current through the shunt or error field providing feedback for the field required on the shunt.

FIGS. 6(a) and 6(b) show computations of the toroidal components of the magnetic field outside the toroidal field coils (e.g. TF coil windings 14) for three different scenarios. The first scenario is perfectly-balanced currents. The second scenario is a winding pack in the measurement plane de-rated by I/N (i.e. one winding or turn lost in a diffuse manner). The third scenario is a winding pack de-rated by I/N but shifted 1/M of a full rotation from the measurement plane, where M is the total number of TF coils in the design (M=18 for the particular design simulated in the computations of these Figures).

While thorough in-vessel measurements can characterize static error fields, drifting error fields may be measured on the outside of the winding packs, and perhaps even outside of the vacuum vessel. FIG. 6(a) shows calculations for the toroidal field measured radially outside of the furthest extent of the winding pack at z=0 (i.e. the horizontal midplane of the tokamak or of the TF coil). The differential of Bo to the purely-balanced case is shown in FIG. 6(b). The magnitude of the differential, as well as the fractional differential, both suggest a small but detectable signal in the case of a single dropped turn, especially if the measurement location is optimized.

It is also possible to detect a dropped turn by measuring the radial field component, BR. In this case, if the measurement is made around z=0, when all coils are perfectly balanced and without build error, and when the poloidal field coils are not energized, then the radial field vanishes. But when a dropped turn exists in a TF coil, a measurable radial field will appear around the middle of the neighboring coil. FIG. 7 shows how this field value decays as the radial distance from the coil is increased. With a signal of tens of mT against a small background, the signal-to-noise ratio of this measurement may be high enough to permit effective use in trimming.

These calculations suggest that a small number of measurements of BR or Bo or both, made outside each winding pack e.g. by magnetic field sensors 28, may be adequate to detect and localize a drop in field from a particular toroidal field coil, as well as to provide feedback for the trim schemes described above. Alternately, a small number of measurements of the azimuthal current (e.g. using current sensors 30) may detect deviations from a desired current level, providing the same detection and feedback mechanism using different means.

FIG. 8 is a flowchart for a method 50 of operating a magnet system having a superconducting electromagnet and a bypass circuit (e.g. any of magnet systems 10, 20, 30, or 40). The electromagnet may have a first (input) terminal and a second (output) terminal, and the bypass circuit may be coupled to the first and second terminals in parallel, as described above and shown in FIGS. 2 through 5.

The method 50 includes a first process 52 of providing a current through the electromagnet to thereby cause the electromagnet to produce a magnetic field. In the context of a tokamak reactor, such as that of FIG. 1, the electromagnet may be part of a toroidal field coil, and the process 52 may include charging the TF coil.

The method 50 continues with a second process 54 of measuring at least one field component of a magnetic field produced by the superconducting electromagnet. Either an azimuthal field or a radial field of the superconducting electromagnet may be measured directly, using magnetic field sensors known in the art. Optimal placement of these sensors, and a useful interpretation of the sensed field values, will depend particularly on the design of the electromagnet, and more generally on the design of the system in which the electromagnet exists, such as a tokamak.

Alternately, the field may be measured indirectly, using a current sensor for detecting current flow through the electromagnet as a proxy. In some embodiments, measuring the azimuthal current might be achieved by using, for example, a fiber-optic current sensor wrapped around a leg of the TF coil. The azimuthal or radial field components then may be computed from the measured current flow using a spatial model of the electromagnetic properties of the electromagnet and/or the magnet system of which it forms a part.

The method next includes a third process 56 of diverting a portion of the current to or through the bypass circuit based on the measurement. Illustratively, when the bypass circuit includes a resistive shunt, this diversion may be accomplished by adjusting a resistance of the resistive shunt. Diverting current to the bypass circuit necessarily trims the current flowing through the superconducting electromagnet. The third process 56 may be implemented, for example, using the structures discussed above, especially in connection with FIGS. 2 through 5. Thus, the bypass circuit may have switches coupled in parallel that are opened or closed to regulate the flow of current through the bypass circuit.

As described above, the switches of the bypass circuit may be transistors whose open/closed state is controlled by adjusting a coupled voltage (e.g. a gate voltage). Alternately, the switches of the bypass circuit may be superconducting elements whose open/closed state is controlled by adjusting a temperature. Temperature adjustment may be accomplished by enabling or disabling a heating element, or directing a cryogen toward or away from the switch. It is appreciated that other structures and techniques may be used in accordance with the method 50 to divert the flow of current away from, or back toward the electromagnet to maintain the electromagnet at a desired performance level. For example, superconducting bypass switches also may be actuated by raising or lowering the local magnetic field through the bypass such that it is above or below the critical field.

FIG. 9A illustrates a magnet system 60 having TF coil windings 62 and a bypass circuit (shunt) 64. The variable-resistance shunt 64 uses a piece of normally-conductive material, such as copper, whose conductivity is controlled thermally by means of a heater. In FIG. 9A is shown a long shunt 64 in a serpentine pattern, providing an alternate current path between leads of the winding pack 62. Such a shunt 64 may be constructed of a composite of multiple sections, in parallel. According to illustrative calculations, a copper shunt 64 of length 1 meter, cross-sectional area 1.8 cm², heated at the center 66 with about 30 watts to achieve a temperature profile with 300 K in the center 66, and with ends 68a, 68b fixed at 77 K (i.e. nitrogen condensation temperature), can achieve an increase of resistance of a factor of about 6 to 11 times, relative to the resistance with the heater disengaged.

FIG. 9B likewise illustrates a magnet system 70 having TF coil windings 72 and a bypass circuit 74a, 74b (collectively, “shunt 74”). The variable-resistance shunt 74 uses a normally-conductive material, such as copper, whose conductivity is controlled mechanically by means of, for example, a press. Here, one or more individual shunts 74a, 74b, each consisting of two halves that are mechanically pressed together, may be activated to achieve a desired parallel resistance. The design of the shunt 74 depends both on the contact resistance, as well as the resistance through the bulk of the shunt halves; for demonstrative purposes, for a desired resistance of 11 μΩ, with a length of about 0.3 m, and conductivity of 5×10⁸ S/m (corresponding to copper at 77 K), and neglecting the contact resistance (which, in fact, may be the dominant contribution), the cross-sectional area of such a shunt leg would need to be about 0.5 cm². The point of this numerical example is to show that the dimensions of such shunts are readily achievable, while leaving room for steel supports.

In the foregoing detailed description, various features are grouped together in one or more individual embodiments for the purpose of streamlining the disclosure. This method of disclosure is not to be interpreted as reflecting an intention that the claims require more features than are expressly recited. Rather, inventive aspects may lie in less than all features of each disclosed embodiment.

Having described implementations which serve to illustrate various concepts, structures, and techniques which are the subject of this disclosure, it will now become apparent to those of ordinary skill in the art that other implementations incorporating these concepts, structures, and techniques may be used. Accordingly, it is submitted that that scope of the patent should not be limited to the described implementations but rather should be limited only by the spirit and scope of the following claims.

What is claimed is:

1. A magnet system comprising:
a coil having first and second terminals, the coil comprising:
a plurality of windings comprising a high temperature superconductor coupled between the first and second terminals, and
conductive material disposed between, and in electrical contact with, each of the plurality of windings; and
a bypass circuit, coupled to the first and second terminals of the coil in parallel with the plurality of windings, the bypass circuit having one or more controllable, current-carrying paths wherein multiple such paths are arranged in parallel with each other.

2. The magnet system of claim 1, wherein the coil does not include any insulating material disposed between windings of the plurality of windings.

3. The magnet system of claim 1, wherein the bypass circuit is coupled to the first and second terminals of the coil via a superconducting bus.

4. The magnet system of claim 1, wherein at least one of the current-carrying paths comprises a switch.

5. The magnet system of claim 4, wherein at least one of the current-carrying paths further comprises a resistor in series with the switch.

6. The magnet system of claim 4, wherein the switch is a transistor.

7. The magnet system of claim 6, wherein the transistor is a metal-oxide-semiconductor field-effect transistor (MOSFET).

8. The magnet system of claim 6, wherein the bypass circuit comprises at least one hundred current-carrying paths, each such path comprising a transistor.

9. The magnet system of claim 4, wherein the switch comprises a superconducting material, the switch is in an open state when the superconducting material is above its critical temperature, and the switch is in a closed state when the superconducting material is below its critical temperature.

10. The magnet system of claim 9, further comprising a heating element for maintaining the superconducting material above its critical temperature.

11. The magnet system of claim 9, wherein the bypass circuit comprises at least ten current-carrying paths, each such path comprising a switch having the superconducting material.

12. The magnet system of claim 4, wherein the switch comprises a superconducting material, the switch is in an open state when the superconducting material is above its critical field, and the switch is in a closed state when the superconducting material is below its critical field.

13. The magnet system of claim 12, further comprising an electromagnet or a movable permanent magnet for opening or closing the switch.

14. The magnet system of claim 1, wherein the bypass circuit comprises a normally-conducting resistor whose resistance may be varied by controlling its temperature.

15. The magnet system of claim 1, further including a resistor in series with the plurality of windings.

16. The magnet system of claim 1, further comprising:
a controller for opening or closing the controllable, current-carrying paths in the bypass circuit, the controller operatively coupled to a magnetic field sensor for measuring a magnetic field produced by the plurality of windings, or to a current sensor for measuring a current passing through the plurality of windings, or to both the magnetic field sensor and the current sensor.

17. A method of operating a magnet system comprising a superconducting electromagnet having first and second terminals and a bypass circuit coupled to the first and second terminals, the method comprising:
providing a current through the superconducting electromagnet to thereby cause the superconducting electromagnet to produce a magnetic field;
measuring at least one field component of the produced magnetic field; and
based on the measurement, diverting a portion of the current through the bypass circuit, thereby trimming the current through the superconducting electromagnet.

18. The method of claim 17, wherein measuring the at least one field component of the magnetic field produced by the superconducting electromagnet comprises measuring either a toroidal component or a radial component of the field of the superconducting electromagnet.

19. The method of claim 17, wherein measuring the at least one field component of the magnetic field produced by the superconducting electromagnet comprises measuring a current flow within the superconducting electromagnet and determining the at least one field component based on the measured current flow.

20. The method of claim 17, wherein the bypass circuit comprises a plurality of switches coupled in parallel, and wherein diverting the portion of the current through the bypass circuit comprises opening or closing a set of one or more switches of the plurality of switches.

21. The method of claim 20, wherein the set of switches comprises transistors, and wherein opening or closing the set of switches comprises adjusting a voltage coupled to one or more of the transistors.

22. The method of claim 21, wherein opening or closing the set of switches comprises operating the transistors at a temperature below 80K.

23. The method of claim 20, wherein opening or closing the set of switches comprises adjusting a temperature of switches in the set.

24. The method of claim 23, wherein adjusting the temperature comprises enabling or disabling a heating element in proximity to the set of switches, or directing a cryogen toward or away from the set of switches.

25. The method of claim 20, wherein opening or closing the set of switches comprises changing a magnetic field incident on the set of switches.

26. The method of claim 25, wherein changing the magnetic field comprises charging or discharging a fixed electromagnet in proximity to the set of switches, or moving a permanent magnet toward or away from the set of switches.

27. A magnet system, comprising:
a coil comprising:
a plurality of windings of a high temperature superconductor; and
conductive material arranged between and contacting windings of the plurality of windings, thereby forming an electrically conductive path between windings of the plurality of windings; and
a shunt circuit coupled in parallel to the coil.

28. The magnet system of claim 27, wherein the shunt circuit comprises a resistive circuit.

29. The magnet system of claim 28, wherein the resistive circuit has a variable resistance.

30. The magnet system of claim 29, wherein the shunt circuit comprises at least one controller configured to adjust the resistance of the resistive circuit.

31. The magnet system of claim 28, wherein the resistive circuit comprises a plurality of switches coupled in parallel.

32. The magnet system of claim 31, wherein the switches are solid state switches.

33. The magnet system of claim 32, wherein the resistive shunt comprises at least 100 of the solid state switches.

34. The magnet system of claim 32, wherein the solid state switches are MOSFETs.

35. The magnet system of claim 31, wherein switches of the plurality of switches are coupled in series to respective resistors.

36. The magnet system of claim 31, wherein switches of the plurality of switches comprise a superconducting material and are configured to be in an open state when the superconducting material is above its critical temperature.

37. The magnet system of claim 31, wherein switches of the plurality of switches comprise a superconducting material and are configured to be in a closed state when the superconducting material is above its critical temperature.

38. The magnet system of claim 27, wherein the coil does not include any insulating material arranged between windings of the plurality of windings.

39. A method of operating a magnet system comprising a magnet and a resistive shunt coupled in parallel to the magnet, the magnet comprising a coil comprising a plurality of windings of a high temperature superconductor and conductive material arranged between and contacting windings of the plurality of windings, thereby forming an electrically conductive path between windings of the plurality of windings, the method comprising:
measuring at least one field component of a magnetic field produced by the magnet; and
adjusting a resistance of the resistive shunt based on the measurement of the at least one field component of the magnetic field produced by the magnet.

40. The method of claim 39, wherein measuring the at least one field component of the magnetic field produced by the magnet comprises measuring an azimuthal field of the magnet.

41. The method of claim 39, wherein measuring the at least one field component of the magnetic field produced by the magnet comprises measuring a radial field of the magnet.

42. The method of claim 39, wherein measuring the at least one field component of the magnetic field produced by the magnet comprises measuring a current flow within the coil and determining the at least one field component based on the measured current flow.

43. The method of claim 39, wherein the resistive shunt is coupled to the magnet via a superconducting bus.

44. The method of claim 39, wherein the resistive shunt comprises a plurality of switches coupled in parallel, and wherein adjusting the resistance of the resistive shunt comprises opening and/or closing one or more switches of the plurality of switches.

45. The method of claim 44, wherein opening and/or closing the one or more switches comprises adjusting the temperature of the one or more switches.

46. The method of claim 45, wherein the one or more switches include a superconducting bypass and wherein adjusting the temperature of the one or more switches comprises disabling a heating element coupled to the superconducting bypass.

47. The method of claim 45, wherein the one or more switches include a superconducting bypass and wherein adjusting the temperature of the one or more switches comprises directing a cryogen to lower the temperature of the superconducting bypass.

48. The method of claim 44, wherein the one or more switches are solid state switches, and wherein opening and/or closing the one or more switches comprises adjusting a voltage coupled to each of the one or more switches.

49. The method of claim 48, wherein the plurality of switches are at a temperature below 80K.
